(19) United States
(12) Patent Application Publication
(10) Pub. No.: US 2006/0167601 A1
(43) Pub. Date: Jul. 27, 2006

(54) Method and apparatus for determining optimized paths of a vehicle

(75) Inventors: Ulrich Henning, Feldkirchen (DE); Winfried Lohmiller, Muenchen (DE); Anton Walsdorf, Vaterstetten (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/305,031

(22) Filed: Dec. 19, 2005

(30) Foreign Application Priority Data
Dec. 17, 2004 (DE) 10 2004 061 636.1

(51) Int. Cl. G01M 17/00; G06F 19/00; G06F 7/00

(52) U.S. Cl. 701/30

(57) ABSTRACT

A computer implementable process for determining optimized paths for a vehicle includes the following steps: (a) evaluation of all nodes or grid points of a defined search space based on costs arising at these nodes for desired paths, starting from both a first reference node and a second reference node, and determining cost-effective desired paths starting from each respective reference node; (b) formation of cost-effective desired paths extending between the first and the second reference node including at least a combination of desired-path sections which extend from the first and second reference nodes respectively, to an intersecting point of the respective cost-effective desired paths; and (c) selection of a cost-optimized desired path extending between the first and second nodes comprising the potential combinations of desired-path sections which start from the first and second reference nodes respectively, on the basis of a defined criterion.

### BACKGROUND AND SUMMARY OF THE INVENTION

This application claims the priority of German patent document 10 2004 061 636.1, filed Dec. 17, 2004, the disclosure of which is expressly incorporated by reference herein.

The invention relates to a computer implementable process for determining an optimized desired path for a vehicle, and a system for determining such a path. The vehicle may be a landcraft, a watercraft or an aircraft (such as a manned or unmanned airplane, a rocket, a missile or a drone.)

The technical article “Algorithmische Graphentheorie” (Algorithmic Graph Theory) by Volker Turau, Addison-Wesley 1996 discloses an algorithm for determining a path between a starting point (sometimes referred to herein as a “first reference point”) and a destination point (sometimes referred to as a “second reference point”), which is optimal according to defined optimization criteria. According to this known process, a path between a defined starting point and a defined destination point is determined in a region that is modeled by a graph or a grid. Beginning from the starting point, the routes to each adjacent grid point or neighboring point are examined according to optimization criteria. In the neighboring points, the determined costs and the routes leading there are stored. This process is repeated for neighboring points of these preceding neighboring points. Only the most favorable costs and the pertaining route are in each case stored in each of these points. This step-by-step determination of the most favorable routes is continued until the most favorable route is determined to the destination point. The result is the route from the starting point to the destination point which is optimal according to the defined optimization criteria. In practice, this process requires relatively high expenditures, if additional criteria (such as a required path length or travel time) must be met precisely.

It is therefore an object of the invention to provide an efficient method and apparatus for determining an optimum desired-path if additional criteria, such as a given path length or travel time must be met precisely.

This and other objects and advantages are achieved by the method according to the invention for determining a desired path for a vehicle in a navigation system, which includes the following steps:

(a) Evaluating all nodes or grid points of a defined search space, based on costs arising at these nodes for the desired paths starting from first and second reference nodes, and determining cost-effective desired paths starting out from each respective reference node;

(b) Forming cost-effective desired paths extending between the first and second reference nodes, including at least a combination of desired-path sections which extend from the first or the second reference node to an intersecting point of the respective cost-effective desired paths;

(c) Selecting a cost-optimized desired path extending between first and second reference nodes, which path consists of the potential combinations of desired-path sections which start from the first and second reference nodes respectively, based on a defined criterion, wherein for a desired path section determined at a Point b) or sequence of desired path sections, the path of the vehicle between the corresponding nodes is computed taking into account motion equations, and only those desired paths are selected at Point c) which, on the basis of the motion equations, are within definable limits and can be physically driven by the vehicle.

According to a feature of the invention, it can be provided that, during the determination of the at least one cost-effective desired path starting out from the respective reference node, nodes of the defined search space are evaluated in steps according to the costs arising at these nodes and, at each node that desired-path section is selected which is most cost-effective.

It may also be provided that the process for the determination of the cost-effective desired path is terminated when the following criteria have been met:
the determined cost-effective desired paths exceed a defined travel time or a generalized route length for the covered route of the vehicle;
all nodes of a search space have been evaluated.

In the process or the system, the costs can be formed:
from a threat value for the vehicle which can be derived particularly from a coefficient that measures the probability of a hostile weapons effect, visibility of the vehicle, or combinations of these values;
from a travel time or a generalized route length for the covered route of the vehicle, which can be determined based on the fuel consumption, the route length, travel time of the vehicle, or combinations of these values;
by forming the integral of movements of control elements, in which case, the object may be to minimize control expenditures with respect to the staying power or the adaptability of the vehicle;

from additional costs in the form of heuristic terms by taking into account characteristics of the problem space which are not to be modeled explicitly, as a further dimension.

According to the invention, a system is also suggested for determining a desired path of a vehicle, which has:

(a) a module for evaluating all nodes or grid points of the defined search space according to the costs of the desired paths arising at these nodes, starting out from a first reference node and a second reference node, and determining cost-effective desired paths starting out from each respective reference node;

(b) a module for forming cost-effective desired paths extending between the first and second reference nodes, including at least a combination of desired-path sections which extend from the first or second reference node to an intersecting point of the respective cost-effective desired paths;

(c) a selection module for selecting a cost-optimized desired path extending between first and second reference nodes consisting of potential combinations of desired-path sections which start from the first and second reference nodes respectively, based on a defined criterion.

One advantage of the invention is that computing expenditures can be reduced by the direction of the dimension of the search problems by one dimension, particularly the travel time.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation of the search space during the determination of cost-effective desired paths according to the invention; and

FIG. 2 is a schematic representation of the search space after the construction of the cost-effective desired paths.

### DETAILED DESCRIPTION OF THE DRAWINGS

According to the invention, a cost-optimized desired path is generated for a vehicle (particularly an airplane) on a grid or a regular or irregular distribution of grid points or nodes in a search area, between two reference points or roots W1, W2 (that is, between a defined starting point and a defined destination point). According to the process, first, in each case, at least one, and preferably several, cost-effective desired paths are determined on the one hand, from a first reference point and, on the other hand, from a second reference point. This determination is based on an analysis of all nodes or grid points of the defined search space according to the costs of potential desired paths arising at the edges between the nodes. From a combination of these cost-effective desired paths (and in the latter case, from a selection of these cost-effective desired paths), a cost-optimized path is determined between two roots W₁, W₂ (that is, a desired path leading from the starting point to the destination point). In a preferred embodiment of the invention, the at least one cost-effective desired path is a cost-optimal desired path.

In a visual representation of the desired paths from above, the desired paths which start out from a first reference point have the shape of branches of a tree or a branching structure, with the first reference point W₁ situated in the lower area of the trunk or in its root area (referred to herein as the first root W₁). Similarly, the desired paths starting from the second reference point W₂, also have the shape of a tree or branching structure, with the second reference point being referred to as a second root W₂. The intersecting points of the trees or branching structures are potential coupling points at which the branches (that is, the cost-effective desired paths starting out from different roots W₁, W₂) can be connected to form desired paths connecting the two reference points or roots W₁, W₂. (In an extreme case, a branching structure may have only one cost-effective desired path.) From the potential combinations of the at least one cost-effective desired path or the cost-effective desired paths which start out from different roots, a cost-optimized desired path extending between these roots W1, W2 or reference points is selected according to predefined criteria.

In a chain-type fashion, this process can be repeated between at least one of the above-mentioned reference points and another reference point once, and then again with respect to further reference points, thus being repeated once or several times.

The cost-optimized desired path is generated in particular by means of a grid which is defined with respect to the area, has grid points or nodes, and models the relevant area or terrain in a given graph or search space D, using motion equations to describe potential routing of the airplane between grid points.

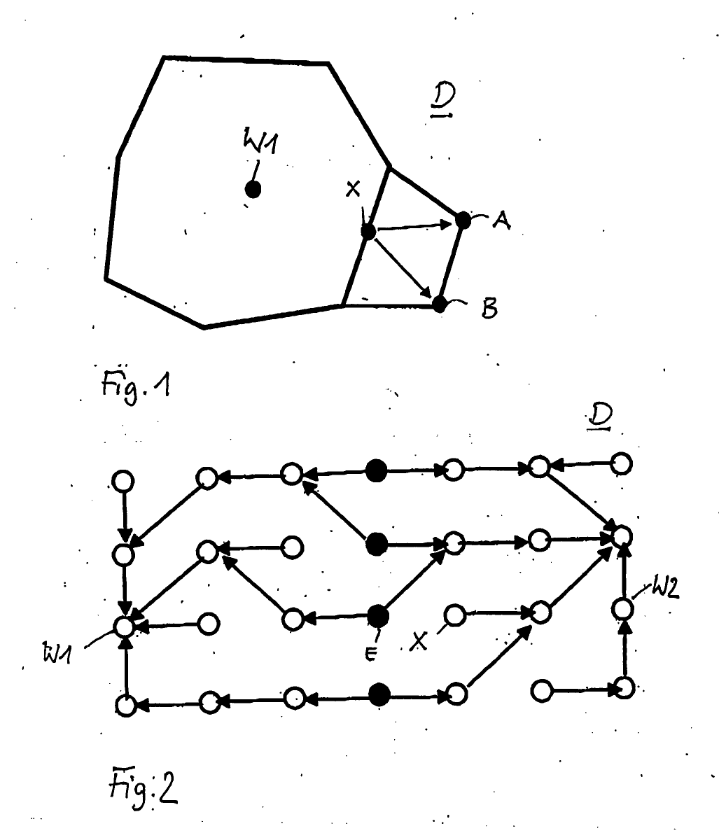

As shown in FIGS. 1 and 2, the graph or search space D in the form of a grid of a defined dimension is formed by a quantity of nodes by which states of the system are modeled at discrete potential locations. Such nodes are mutually connected by “edges”, potential which are routes between the locations. For the edges, costs can be determined or given in the form of a number.

Costs (with Respect to the Edges of the Graph):

The determination of the costs arising at edges between nodes, by which it is decided which route is used as a component of the cost-effective desired path, can be based on the following influencing variables or parameters:
a threat value for the vehicle which can be derived in particular from a coefficient which measures the probability of a hostile weapons effect, the visibility of the vehicle, or combinations of these values;
a travel time or a generalized route length for the covered route of the vehicle, which can be determined based on fuel consumption, the route length, vehicle travel time, or combinations of these values;
control expenditures for which can be determined by forming the integral of the movements of the control elements, in which case the object may be to minimize the control expenditures with respect to the staying power or the adaptability of the vehicle;
additional costs in the form of heuristic terms by which takes into account characteristics of the problem space that are not to be modeled explicitly as a further dimension. This can be useful for reducing the complexity of the computing method resulting from the invention and for reducing the required computing time and the required storage space.

The last-mentioned additional costs can be used as a sort of punishment term for making the extremes of these characteristics more expensive. The algorithm falsifies the optimum by means of these additional costs. Correction functions can also be used for the compensation.

In a preferred embodiment of the invention, the travel time of the vehicle (or the flying time of the airplane) is not treated as a state; rather, it is required as a limiting condition that the flying time of the overall path corresponds (within a given tolerance) to a given value. The cost-optimized desired path can be selected from the cost-effective desired paths, using this limiting condition.

One use of the invention is as a module for determining a desired path for an airplane, for the terrain following flying. In this case, it may be particularly advantageous not to completely represent the flight altitude in the states, but rather to punish large changes in terrain elevation by an additional cost amount, or to add up their costs, when the airplane cannot follow a desired path course because of the flying performance which is taken into account in the form of motion equations.

In the process according to the invention, a cost variable is used such that when several cost fractions are applied, as a function of the respective application case, the various cost fractions are weighted in a predefined manner in this one cost variable.

According to the invention, in forming the alternative cost-effective desired paths and in the further process steps, permissible motion possibilities of the vehicle are factored in by imposing conditions, in order to take into account only those desired paths which the airplane can fly, based in particular on its flying performance or the flying physics. The state of the vehicle determined or given at the respective location site can be formed of the following components or partial states:
The position of the vehicle in the North or South direction;
the position of the vehicle in the East or West direction or laterally;
the altitude of the vehicle above a reference altitude;
the alignment of the airplane in space and particularly the traveling direction or the flight direction of an airplane, wherein in the case of an airplane, additional quantities such as the flight state values (for example, the roll angle), can be used, and wherein the assignment of the alignment to the respective node can take place in different ways and particularly by using the value during the movement from the preceding to the respective considered node;
a time-dependent threat value, particularly for threats which become dangerous only if they last for a given time, in which case the time-dependent threat is modeled by a partial state which changes over time;
the speed of the vehicle in order to take into account the fact that the motion equations of the vehicle can change at different speeds; when the process is applied to an airplane, the dynamic climbing ability can also be illustrated by means of the speed;
additional states depending on the application case.

The motion equations of the vehicle or of the airplane are treated as motion possibilities of the vehicle and are used at each node for defining the potential edges in the graphs. This means that the preceding movement along an edge, which precedes in the course of the desired path, can limit the movement which follows, if the latter exceeds a limit permissible on the basis of the motion equations.

In the process according to the invention for generating a cost-effective desired path, a predefined search space D (FIG. 1) is used as the basis. The algorithm for determining optimized paths or routes is developed between first and second reference points or roots W₁, W₂ (FIGS. 1 and 2), which are components of the graph or quantity of grid points.

In a first step, at least one cost-effective desired path is determined for each of two reference nodes or reference points, with at least one cost-effective desired path extending from each reference node. When determining the at least one cost-effective desired path originating from the respective reference node (W₁, W₂), preferably all nodes or grid points of the given search space are evaluated according to the costs arising there, and at each node the most cost-effective route to the next node is selected. In a normal case, the individual steps according to the invention result in a plurality of cost-effective desired paths. When forming several cost-effective desired paths, in a visual representation, these have a branching or tree structure which starts out from the respective root reference node or root W₁, or W₂ and whose start is situated in the respective reference points or roots.

Each cost-effective desired path therefore represents a sequence of cost-effective routes which extend from a reference point, between nodes of a given quantity of nodes in the search space D. In determining each cost-effective desired path, a decision is made at each node whether the adjacent node of the search space D is used as the next path point. In this case, that adjacent node at which the lowest costs arise is identified as the next route point.

A preferred embodiment of the invention, uses the known Dijkstra algorithm (Dijkstra, Dynamic Programming; cf European Patent Document No. EP 1 335 315) to determine the cost-effective desired paths, by way of desired path sections which emanate from the respective first and second reference W_{1 and W}₂ nodes, as follows:

In the case that the path to node X is the least costly path section which starts from either the starting or destination reference point, in the next computing step the costs are determined for each following node A, B, C, D, E, F, G, H.

In this case, the costs are determined which arise when the vehicle is moved from node X to each of the potential following points A, B, C, D, E, F, G, H, and these partial costs are added to the costs already arisen in node X. The costs which have arisen at the most cost-effective desired path section leading to the node A are assigned to each following node, for example, to the following node A. If, at this computing step, no other cost-effective desired position section exists which leads to node A, those costs are assigned to node A which have occurred for the desired path section leading via node X. If, in contrast, a cost-effective desired path section leading to node A already exists, the costs which arose in node X because of the already existing desired path section are compared with the cost attributable to the desired path section leading via node A, and the lower costs are assigned to node A. In addition, in node A, the desired path section leading to this node which has led to the lower costs in node A is registered as the most cost-effective desired path section in the respective computing step.

This process is then repeated recursively with respect to the node X that is then the leat costly node (that is, has the least costly route connected to the starting or destination point).

With respect to the computation, preferably the cost 0 is assigned to each reference node or each root W₁, W₂. In addition, it is preferable that the costs (for example, the costs with respect to node A) are stored, in which case this node may already have been reached by another route, so that costs for this node have already been entered. In this case, as required, the costs previously stored at this node are overwritten if the desired path section for which the costs are determined in the respective computing step is more cost-effective in node A than another path which leads to this node A. Otherwise, the costs of the respective desired path section changed in the respective computing step are entered in the following node A. In this case, node X is additionally stored as the last predecessor together with its predecessors. If another predecessor was already registered in A, it is replaced by that predecessor via which a more cost-effective desired path section extends, so that a worse desired path section is replaced by a better desired path section.

The process for determining the cost-effective desired path can be terminated whenever:
the determined cost-effective desired paths exceed a given travel time or a generalized route length for the covered route of the vehicle;
all nodes of a search space have been evaluated.

The step of determining the cost-effective desired paths is preferably concluded when the given search space D has been searched (that is, the cost associated with the potential movements between the nodes have been evaluated for all nodes of the search space). Thereafter, all nodes of the graph, which can be reached from the respective root (reference nodes W₁, W₂), are provided with costs and flying time or route lengths. In addition, as a result of the storage of a predecessor, for each of these nodes, an unambiguous cost-effective desired path is determined originating from the respective root, such that a recursive tracking of the predecessors can take place to the root. The edges between successive or adjacent nodes are no longer defined by the motion equations but explicitly by the references to the predecessor nodes.

In a second step, from a selection of these cost-effective desired paths each originating from a root (reference mode W₁ or W₂), at least one cost-optimized desired path and, in the normal case, a plurality of cost-optimized paths are determined. In this case, intersecting points of cost-effective desired paths, which originate from different roots W₁, W₂, are used as connection points for the combination of the respective desired path sections. Thus, with respect to the intersecting points of cost-effective desired paths with different roots, the potential combinations of path sections are formed which extend from the respective roots W₁, W₂ to the intersecting point. These combinations of sections of cost-effective desired paths originating from a root form cost-effective desired paths extending between the respective roots W₁, W₂.

In a third step, from potential cost-effective desired paths extending between the roots W₁, W₂, on the basis of at least one predetermined criterion, a cost-optimized desired path is selected which meets the travel time requirement.

In one embodiment of the invention, such selection can be made on the basis of a given route length or travel time. In this case, the criterion can be used in such a manner that a travel time or traveling route is reached, fallen below or exceeded within given limits. Of all combined desired paths which meet the traveling time requirement, a cost-optimized desired path is then selected as the overall result. In this manner, a desired path optimization can then take place on the basis of secondary conditions.

This determination of a cost-optimized desired path from among a number of cost-effective desired paths between two first reference nodes or roots W₁, W₂ can be repeated several times between one of the reference nodes and another reference node, in which case one of the two first reference nodes is the starting point of the development of cost-effective desired paths, as well as cost-optimized desired paths to two different roots. In this manner, by means of the process according to the invention, a cost-optimized desired path can be determined between a total of three roots. When this process for determining a cost-optimized desired path from a number of cost-effective desired paths is repeated, the number of reference node roots between which one or more cost-optimized desired paths are formed can be further increased.

According to the invention, a system for determining a desired path is also provided, in which the process according to the invention is implemented. The system can be used for a manned or an unmanned vehicle. Such a system may be a planning system which feeds the determined desired path to a path guiding system.

In particular, such a system has a module with functions for evaluating all nodes or grid points of the given search space, based on the costs arising at these nodes for desired paths which start out from first and second reference nodes. This module also has functions for determining cost-effective desired paths which originate from one reference node respectively.

In addition, the system has a module with functions for forming cost-effective desired paths which extend between a first and a second reference node W₁, W₂. In this case, cost-effective desired paths are formed from at least one combination of desired path sections extending from the first or the second reference node to an intersecting point of cost-effective desired paths.

The system also comprises a selection module with functions for the selection of a cost-optimized desired path extending between first and second nodes W1, W2 from the potential combinations of desired path sections which originate from the first and from the second node respectively, on the basis of a given criterion.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A process for determining a desired vehicle path between first and second reference nodes in a defined search area that includes a plurality of nodes, said process comprising:
(a) evaluating all nodes of the defined search space based on the costs associated with desired paths connecting them with the first and second reference nodes, and determining cost-effective desired paths starting out from each respective reference node;
(b) forming cost-effective desired paths extending between the first and second reference nodes, said paths including at least a combination of desired-path sections which extend from the first and second nodes respectively to an intersecting point of the respective cost-effective desired paths; and
(c) based on a defined criterion, selecting a cost-optimized desired path extending between the first and second reference nodes, which cost optimized desired paths consists of potential combinations of desired-path sections that start from the first and second reference nodes respectively; wherein,
determination of a desired path section or sequence of path sections between corresponding nodes for a particular point b is computed taking into account motion equations, and only those desired paths are selected at Point c. which, on the basis of the motion equations, are within definable limits and can be physically driven by the vehicle.

2. The process according to claim 1, wherein:
in determining at least one cost-effective desired path starting out from a respective reference node, nodes of the defined search space are evaluated in steps according to the costs arising at these nodes; and
at each node, a desired-path section is selected which is most cost-effective.

3. The process according to claim 1, wherein determination of the cost-effective desired path is terminated as soon as the determined cost-effective desired paths exceed a defined travel time or a generalized route length for the covered route of the vehicle.

4. The process according to claim 1, wherein determination of the cost-effective desired path is terminated as soon as one or more cost-effective desired paths have reached a respective other reference point.

5. The process according to claim 1, wherein determination of the cost-effective desired path is terminated, with a simultaneous determination of the respective most cost-effective desired path sections from both reference nodes, as soon as at least one intersecting point of the most cost-effective desired path sections exist which start out from different reference nodes.

6. The process according to claim 1, wherein determination of the cost-effective desired path is terminated as soon as all nodes of a search space have been evaluated.

7. The process according to claim 1, wherein, the costs are formed from a threat value for the vehicle which is determined based on a coefficient which measures a probability of a hostile weapons effect, on visibility of the vehicle or on combinations of these values.

8. The process according to claim 1, wherein the costs are formed from a travel time or a generalized route length for the covered route of the vehicle, which can be determined from fuel consumption, route length, the travel time of the vehicle, or combinations of these values.

9. The process according to claim 1, wherein the costs are formed based on control expenditures associated with edges between respective nodes, which can be determined from an integral of the movements of control elements, in which case, with respect to the staying power or the adaptability of the vehicle, the object may be to minimize control expenditures.

10. The process according to claim 1, wherein the costs are formed from additional costs in the form of heuristic terms by which characteristics of the problem space which are not modeled explicitly as a further dimension, are punished.

11. A system for determining a desired path of a vehicle, said system comprising:
(a) a module for evaluating all nodes or grid points in a defined search space, based on costs arising at these nodes for desired paths starting from a first reference node and a second reference node, and determining cost-effective desired paths starting out from each respective reference node;
(b) a module for forming cost-effective desired paths extending between the first and second reference nodes, said paths including at least of a combination of desired-path sections which extend from the first and second nodes respectively to an intersecting point of the respective cost-effective desired paths; and
(c) a selection module for selecting a cost-optimized desired path extending between first and second nodes, which cost-optimized desired paths consists of potential combinations of desired-path sections that start from the first and second reference nodes, respectively, based on a defined criterion.

12. The system according to claim 9, wherein said cost-optimized desired path is selected as a function of at least one of route length and travel time.
